(19) United States
(12) Patent Application Publication
(10) Pub. No.: US 2004/0149536 A1
(43) Pub. Date: Aug. 5, 2004

(54) Force-exerting element for a friction clutch

(75) Inventors: Sebastian Vogt, Bad Neustadt (DE); Markus Heiartz, Wurzburg (DE); Michael Peterseim, Bergrheinfeld (DE); Frank Hirschmann, Niederwerrn (DE); Christoph Kleuker, Gochsheim (DE); Angelika Ebert, Schweinfurt (DE); Bernd Peinemann, Niederwerrn (DE); Matthias Muller, Rothlein (DE); Wolfgang Reisser, Sennfeld (DE); Matthias Dorfler, Schonungen (DE)

Correspondence Address: COHEN, PONTANI, LIEBERMAN & PAVANE, 551 FIFTH AVENUE, SUITE 1210, NEW YORK, NY, 10176, US

(73) Assignee: ZF Sachs AG

(21) Appl. No.: 10/638,900

(22) Filed: Aug. 11, 2003

(30) Foreign Application Priority Data
Aug. 10, 2002 (DE) 102 36 842.2
Oct. 22, 2002 (DE) 102 49 046.5

(51) Int. Cl. F16D 13/71

(52) U.S. Cl. 192/89.25

(57) ABSTRACT

A force-exerting element for a friction clutch includes a ring-like body with an outer edge area and an inner edge area. Openings provided in the body include a first group of openings open toward the outer edge area and a second group of openings open toward the inner edge area. The radial extent of circumferentially adjacent openings of the first group of opening and of the second group of openings overlap each other in the radial direction at the ends facing way from their associated edge areas or extend along approximately the same radial area. A radial support arrangement is arranged on the body to provide at least certain areas of support in the radial direction against the effects of centrifugal force.

### BACKGROUND OF THE INVENTION

1. Field of the Invention

The present invention relates to a force-exerting element for a friction clutch, comprising a ring-like body with an outer edge area and an inner edge area, where openings are provided in the body; a first group of the openings is open toward the outside edge area; and a second group of the openings is open toward the inner edge area; and where, at the ends facing away from their associated edge areas, the openings of the first and second groups adjacent to each other in the circumferential direction overlap each other in the radial direction or extend approximately along the same radial area.

2. Description of the Related Art

In clutches of the normally open type, an engaging force is not generated by a force-storing device supported against a housing and a pressure plate. Rather, the engaging force is produced in an engaging system and transmitted by a force-exerting element, which is supported against a housing and a pressure plate in the same ways that, for example, a force-storing device in the form of a diaphragm spring is supported. The force-exerting element, however, transmits the engaging force on the basis of the support lever relationships which are present and supplies essentially no contribution of its own to the force. A force-exerting element 110 of this type produced, for example, by stamping a piece of sheet metal, is shown in FIGS. 1 and 2. It can be seen that this force-exerting element 110 comprises a ring-like body 112 with an outer edge area 114 and an inner edge area 116. Essentially radially oriented openings 118, 120 are formed in this body 112, the two types of openings alternating with each other in the circumferential direction. The openings 118 are open toward the outer edge area 114, and the openings 120 are open toward the inner edge area 116. Openings 118 have a radially inner ends 122 and openings 120 have a radially outer ends 124 which face away from their associated edge areas 14, 16. The radial distance between the radially inner ends 122 of openings 118 and the axis of rotation A is less than the radial distance between the radially outer ends 124 of the openings 120 and the axis of rotation such that the extent of the openings 118, 120 overlap each other in the radial direction, so that basically a material structure extending continuously around in the circumferential direction in a meander-like manner is formed in the remaining material of the body 112. It can also be seen that especially the ends 124 of the openings 120 which are open radially toward the inside are expanded, as is also the case in diaphragm springs. These expanded ends 124 of the openings 120 are situated in the areas of the material of the body 112 between two circumferentially adjacent openings 118. The openings 120 have the effect of creating tongue-like structures in the force-exerting element 110, extending radially toward in the radially inner side. The engaging system mentioned above acts on these tongue-like structures. The radially outer area, e.g., the outer edge area 114, of the force-exerting element 110, for example, can be supported against a clutch housing, while the radially intermediate area can act on a pressure plate. In principle, however, it is also possible for the radially outer area to be supported against, i.e., act on the pressure plate and for the radially intermediate area to be supported against a housing arrangement.

As a result of the previously mentioned meander-like structure of the body 112, which can be seen in FIG. 1, a comparatively flexible lever arrangement is obtained. Despite the fact that the individual lever elements are connected to each other in the circumferential direction by a continuous piece of material, the intrinsic force of these elements is comparatively weak. A problem with this force-exerting element 110 is that the force-exerting element 10 has a certain elasticity or stretchability in the circumferential direction which allows it to also expand in the radial direction as a result of the effect of centrifugal force during rotational operation of the clutch. This radial expansion has a disadvantageous effect on the lever relationships and thus on the actuating force characteristic.

### SUMMARY OF THE INVENTION

An object of the present invention is to counteract the radial expansion of a force-exerting element under the effect of centrifugal force.

The object of the present invention is achieved by a force-exerting element for a friction clutch which includes a ring-like body with an outer edge area and an inner edge area, the body defining openings, wherein a first group of the openings is open toward the outside edge area and a second group of openings is open toward the inside edge area, the ends of circumferentially adjacent openings of the first and second groups overlap each other in the radial direction at the ends facing away from their associated edge areas or extend approximately along the same radial area, and wherein a radial support arrangement is assigned to the force-exerting element to provide it with at least certain areas of support in the radial direction against the effects of centrifugal force.

In the present invention, the radial support of the force-exerting element ensures that the force-exerting element is prevented from expanding in an undefined manner under the effect of centrifugal force.

The radial support may be effected by a radial support arrangement comprising a support ring which surrounds a radially outer side of the ring-like body. To achieve a stable interaction between the force-exerting element and the support, the support ring includes a recess which receives the radially outer edge area of the ring-like body.

When actuating processes are performed, the force-exerting element is deformed by the axial movement of certain of its areas. So that the area of the interaction between the support ring and the force-exerting element does not interfere with this deformation, the outer edge area engages in the recess with a certain freedom of movement with respect to the support ring.

In an alternative embodiment, the outer edge area is held basically without freedom of movement in the recess. To ensure here, too, that there is essentially no interference with the deformability of the force-exerting element and thus no interference with the performance of the clutch-engaging and disengaging operations, the support ring has a torsional elasticity so that it conforms to the movement or deformation of the force-exerting element.

In another alternative embodiment, the support ring may be formed by a pressure plate of a friction clutch. In this case, there is no need for any additional components.

According to another alternative embodiment, the support arrangement comprises a support ring which cooperates with the ring-like body at or near the radially inner edge area. So that, in this embodiment, there can be cooperation between the force-exerting element and the support ring, hook-like support areas are provided on the support ring and/or on the ring-like body, so that there can be a supportive interaction between the two areas.

In another alternative embodiment, the radial support is achieved by providing the support arrangement with a plurality of support projections, which are provided on a carrier, preferably a clutch housing, and which engage in the body.

Because there are basically already several open spaces in the body of the support element as a result of the creation of the openings, at least some of the support projections engage in the body near the openings. It is also possible for at least some of the support projections to engage in the openings in the body, at or near one radial end of the opening. It is also possible, as an alternative, for at least some of the projections to engage in engagement openings in the body especially assigned to the projections.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1a is an axial view of a prior art force-exerting element;

FIG. 1b is an enlarged view of a section of the force-exerting element in FIG. 1a denoted by 1b;

FIG. 2 is a cross-sectional view of the force-exerting element shown in FIG. 1, taken along line II-II in FIG. 1;

FIG. 3 shows the force-exerting element according to FIG. 1 in cooperation with a support ring according to the present invention;

FIG. 4 is a cross-sectional view of the force-exerting element and of the support ring according to FIG. 3, taken along line IV-IV of FIG. 3;

FIGS. 5a-5f are sectional views of various embodiments of the interaction between support ring shown in FIGS. 3 and 4 and of the radially outer area of the force-exerting element;

FIG. 6 is an axial view of a force-exerting element cooperating with a pressure plate according to the present invention;

FIG. 7 shows a cross-sectional view of the force-exerting element according to FIG. 6, taken along line VII-VII of FIG. 8;

FIG. 8 is an axial view of a force-exerting element, the radially inner area of which is cooperating with a support ring according to the present invention;

FIG. 9 shows a cross-sectional view of the force-exerting element according to FIG. 8, cut along line IX-IX of FIG. 8;

FIG. 10 is an axial view of a force-exerting element, which is cooperating with pin-like support projections for radial support; and

FIG. 11 is the force-exerting element according to FIG. 10, taken along line XI-XI of FIG. 10.

### DETAILED DESCRIPTION OF THE PREFERRED EMBODIMENTS

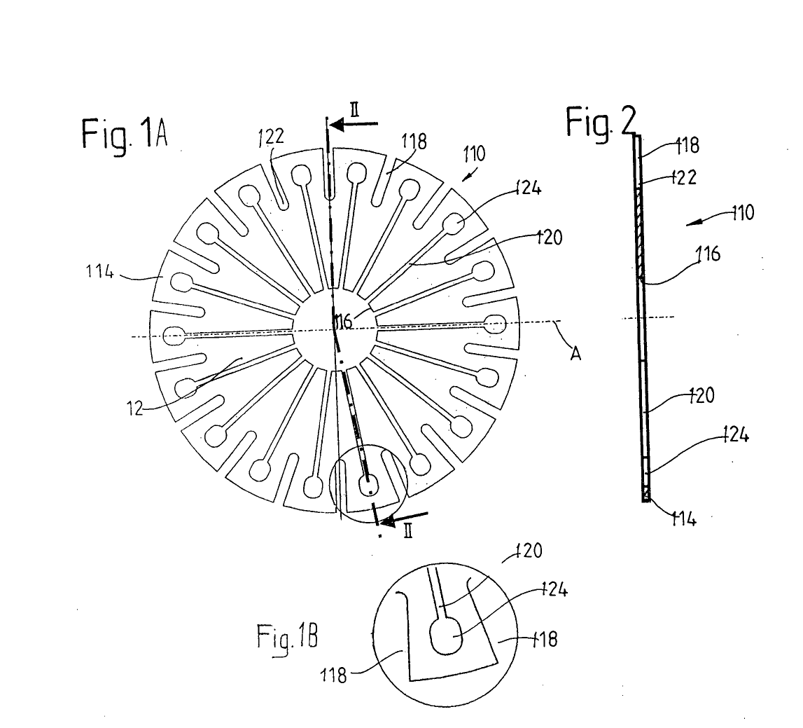

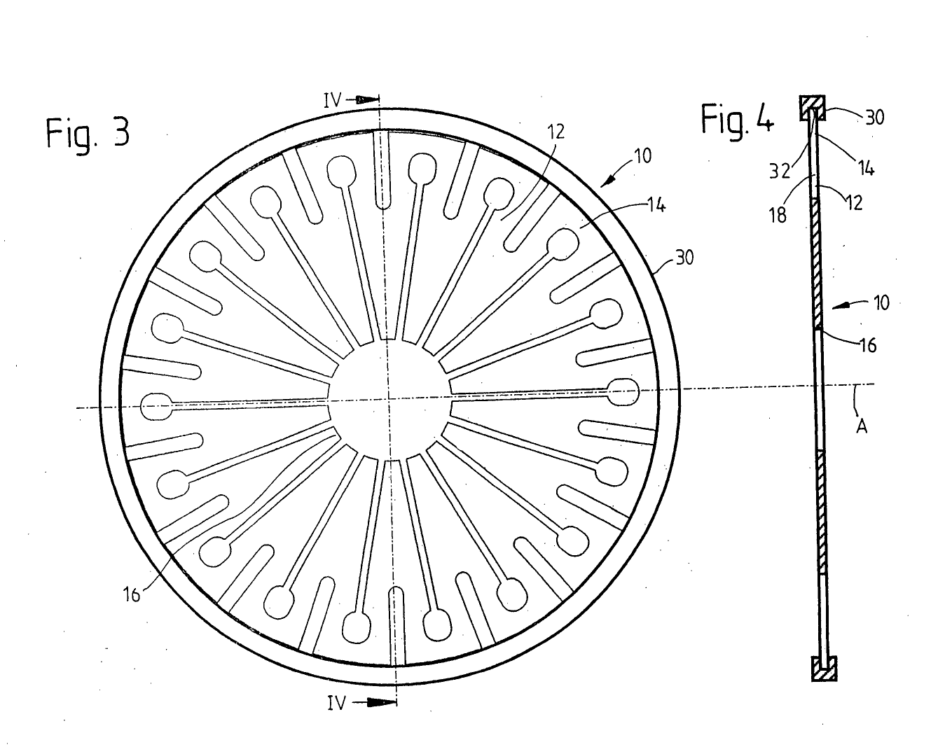

FIGS. 3-11 disclose various means to ensure that an undesirable radial or circumferential expansion of a force-exerting element such as that already described in principle above with reference to FIGS. 1 and 2 will not occur during rotational.

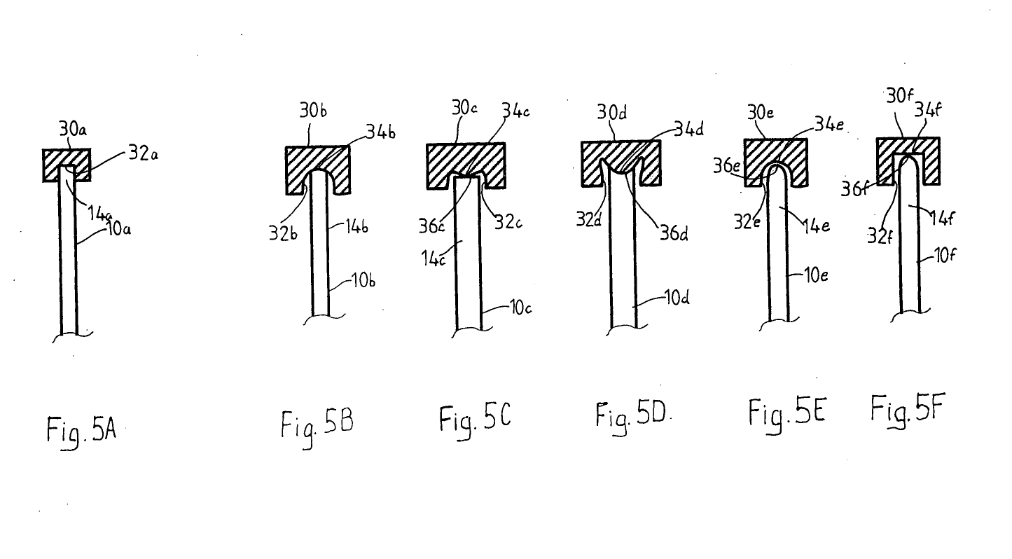

FIG. 3 shows a force-exerting element 10, similar to the above-described for-exerting element 110, cooperating with a support ring 30 which surrounds an outer edge area 14 of the force-exerting element 10. The support ring 30, which is made of metal or plastic, has a groove-like recess 32 which is open toward a radially inner side and which extends continuously all the way around the circumference. The outer edge area 14 of the force-exerting element 10 engages in the recess 32. In the embodiment shown in FIGS. 3 and 4, an enlargement of which is also shown again in FIG. 5a, the outer edge area 14 fits essentially without play in the opening 32 in the support ring 30. So that there is no interference with the deformation of the force-exerting element 10 during the performance of clutch-engaging and disengaging operations, the support ring 30 is fabricated here preferably of a material or with a structure which presents essentially no opposition to the deformation of the force-exerting element 10 associated with the clutch-engaging and disengaging operations. This means that the support ring 30 has torsional elasticity and is preferably fabricated out of an appropriately elastic material such as plastic.

FIGS. 5b-5f show alternative embodiments of the support ring 30 and also of the radially outer area of the force-exerting element 10. These embodiments also ensure that the support ring 30 cooperating with the force-exerting element 10 presents essentially no interference with the deformability of the force-exerting element 10 required for the performance of clutch-engaging and disengaging operations.

It can be seen in FIG. 5b, a recess 32b of a support ring 30b, which is open radially toward the inside, is somewhat wider in the axial direction than the thickness of an outer edge area 14b of a force-exerting element 10b. Furthermore, a base 34b of the recess 32b, which cooperates with the outer edge area 14b, is designed with a concave curvature. Accordingly, the outer circumferential area of the force-exerting element 10b may be designed with a corresponding convex curvature. As a result, the outer edge area 14b may tilt in the recess 32b, even if the support ring 30b itself is stiff and cannot therefore twist.

In the embodiment shown in FIG. 5c, an area with a radially inward-oriented convex curvature is provided at a base 34c of a recess 32c in a support ring 30c. An outer circumferential surface 36c of an outer edge area 14c of a force-exerting element 10c rests on the base 34c. Here, too, the recess 32c is wider in the axial direction than the thickness of the force-exerting element 10c. Accordingly, the force-exerting element 10c is essentially free to move and to undergo deformation associated with clutch-engaging and disengaging operations while at the same time being supported in the radial direction.

In the embodiment shown in FIG. 5d, an outer circumferential surface 36d of a force-exerting element 10d has a concave curvature so that it conforms to the convex curvature of a circumferential surface 36d of a base 34d of a recess 32d in a support ring 30d.

FIG. 5e shows an embodiment which is essentially the same as that according to FIG. 5b. A convex curvature of an outer edge area 14e of a force-exerting element 10e, i.e., an outer circumferential surface 36e thereof, conforms to the concave curvature of a base 34e of a recess 32e in a support ring 30e. In addition, a slight amount of radial play is provided to allow the essentially free deformation of the force-exerting element 10e.

In the embodiment in FIG. 5f, a recess 32f in a support ring 30f is designed with a flat base 34f, the recess 32f being wider in the axial direction than the thickness of a force-exerting element 10f received therein. The force-exerting element 10f has an outer circumferential surface 36f is convexly curved so that when actuating operations are performed, the force-exerting element 10f can execute rolling movements by basically pivoting with respect to the base 34f.

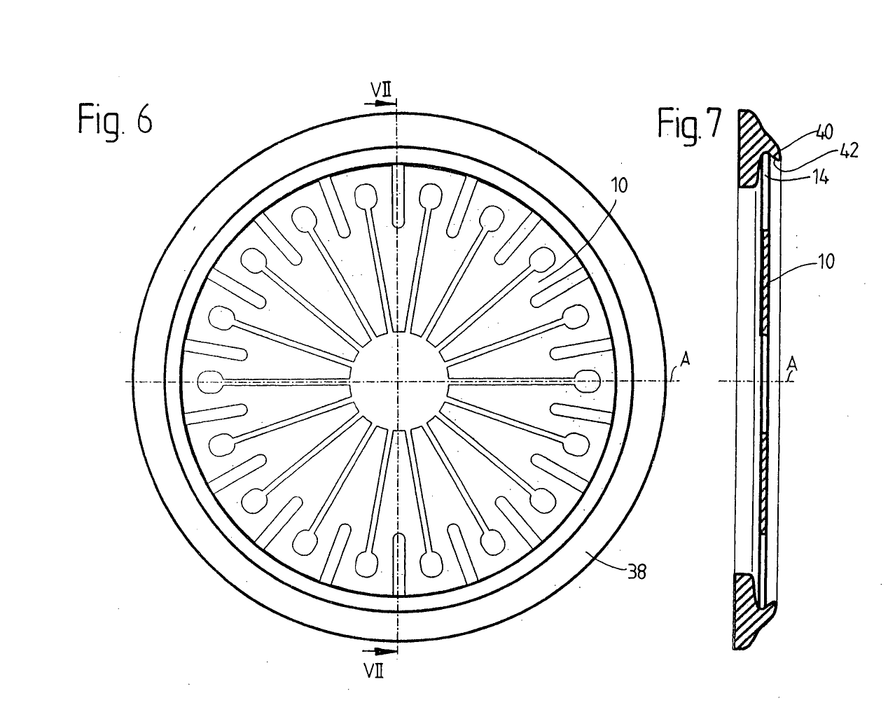

FIGS. 6 and 7 show an alternative embodiment for providing the force-exerting element 10 with support in the radial direction in which a pressure plate 38 of a friction clutch cooperates with the force-exerting element 10. The outer edge area 14 of the force-exerting element 10 acts on the pressure plate 38. Furthermore, the pressure plate 38 has a support section 40 which extends axially and radially around the outer edge area 14 and which has a recess 42 facing radially inward to hold the outer edge area 14. This support section 40 thus assumes the function of the previously described support ring. In this case, therefore, no additional components are required to provide the radial support function. The interaction between the pressure plate 38, which is usually torsionally rigid, and the force-exerting element 10 can thus occur in the manner shown in FIGS. 5b-5f.

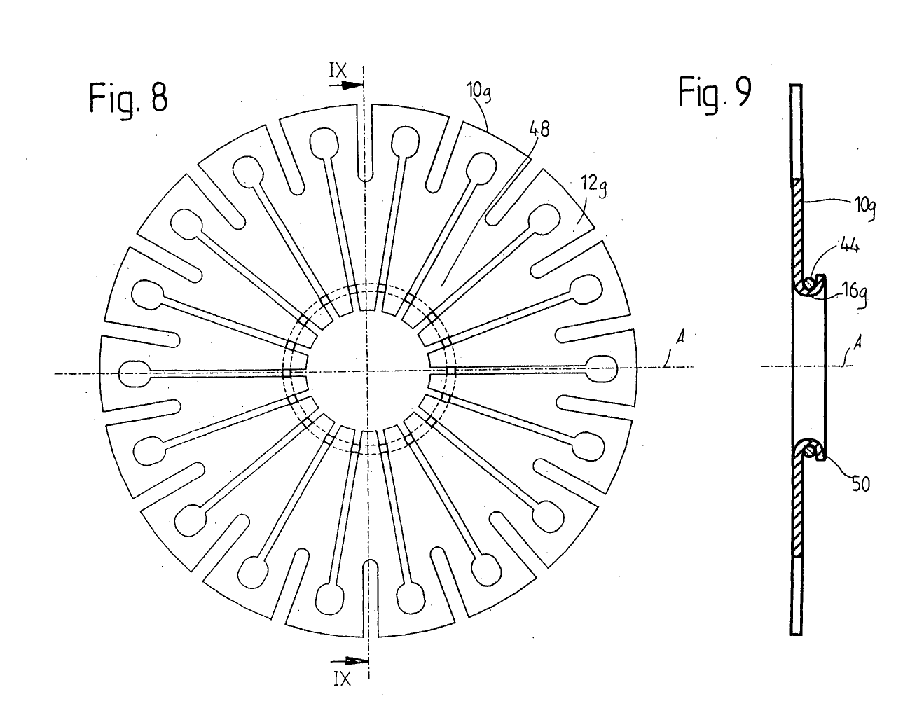

Another alternative embodiment is shown in FIGS. 8 and 9. Here we see a support ring 44, which cooperates with a radially inner area of a force-exerting element 10g. The inner edge area 16g is bent over, so that, in the area of the inner ends of the individual lever sections 48 of the body 12g of the force-exerting element 10g, hook areas 50 are formed which grip the support ring 44 radially from the inside and thus support the force-exerting element 10g radially toward the outside. The function of this support ring 44 may also be assumed by a bearing ring of an actuating force transmission bearing of the clutch-engaging system. A groove may be provided in the inside circumferential surface of the ring 44, into which the hook areas 50 of the force-exerting element 10g engage. With respect to the cooperation between the force-exerting element 10g and this type of support ring in the radially inner area, it is also possible for the support ring, which can be fabricated out of, for example, sheet metal, to have hook elements, which engage in openings in the radially inner edge of the body 12g of the force-exerting element 10g. The exact radial positions of these openings can also be selected, for example, so that the interaction between the force-exerting element 10 and this support ring interferes with the required deformation associated with the clutch-engaging and disengaging operations as little as possible. For example, in cases where the radially intermediate area of the force-exerting element 10 is supported against a housing, the openings into which the hooks of a support ring could engage or with which a support ring could cooperate in this support area.

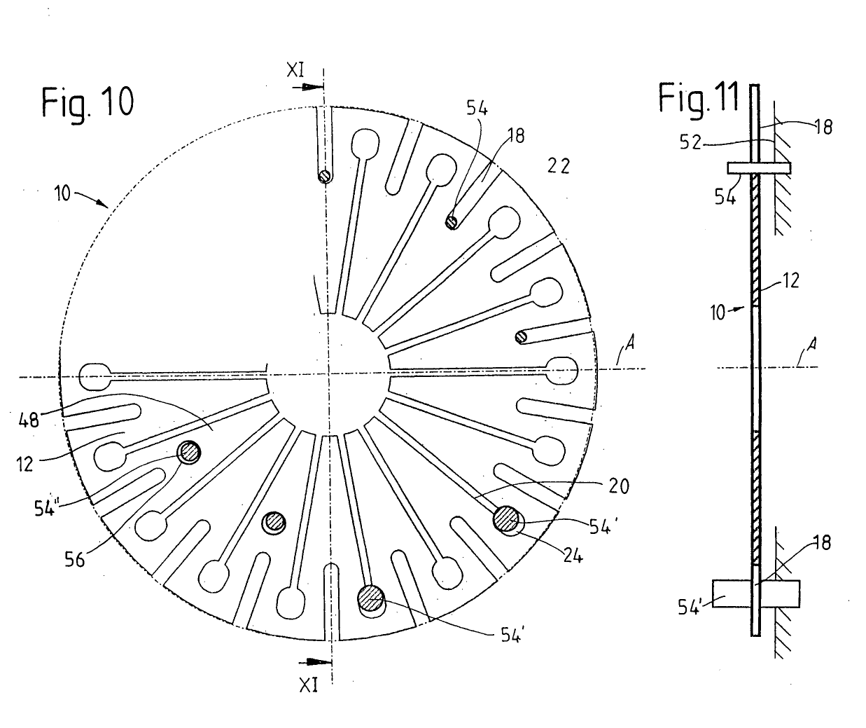

Yet another embodiment of the present invention is shown in FIGS. 10 and 11. In particular, the three drawn-in quadrants of FIG. 10 show three different supports for radially supporting the force-exerting element 10. In the upper right quadrant, support pins 54 are positioned so that they engage in the openings 18, namely, in the radially inner end areas 22 of the openings 18. More specifically, a support pin 54 of this type engages in every other opening 18. In the embodiment shown in the bottom right quadrant, pins 54′ engage in the openings 20 or, as shown in the drawing, in every other opening 20, in the expanded end areas 24 of these openings 20. The pins 54′ thus provide the element with radial support from the outside in the areas where the expanded ends 24 of the openings adjoin the sections with the narrower circumferential dimension. In the quadrant at the bottom left of FIG. 10, openings 56 in a radially intermediate area of the body 12, i.e., of the individual lever sections 48, are assigned to support pins 54″, which can also be seen here. The size of these openings is essentially the same as that of the pins 54″.

It is obvious that more than one of the possibilities shown in the three quadrants discussed above for providing radial support by means of bolt elements mounted on a clutch housing 52 or on a ring-like carrier element can be realized simultaneously for one and the same force-exerting element 10. In place of the pin elements used here, which are separate parts attached to the carrier, it would also be possible in principle to use other support projections, which are designed as integral parts of the carrier, for example, to provide for the radial support of the force-exerting element.

The present invention ensures that, in the case of a force-exerting element which, because of its intrinsic deformability, has the ability to expand in the radial and/or circumferential direction and which is intended to transmit a clutch-engaging force to a pressure plate, the tendency for radial and/or circumferential expansion to occur during rotational operation is counteracted without any essential impairment to the engaging force transmission characteristic of the force-exerting element. It should be pointed out as a matter of principle that a force-exerting element of this type is preferably stamped out of sheet metal, but basically could also be produced out of other materials. In addition, it is possible to influence the deformability or intrinsic force-exerting capacity of a force-exerting element of this type through the selection of the material, of the thickness of the material, and of the shape or arrangement of the openings 18, 20. The greater the radial overlap between the openings which are open radially toward the outside and those which are open radially toward the inside, the “softer” in the circumferential and/or radial directions the force-exerting element will be. The principle of the present invention is basically also applicable when the overlap is not as large as that shown in the figures. That is, the teachings of the present invention also apply when, for example, the radially inner and radially outer end areas 22, 24 of the openings 18, 20 merely approach each other in the radial direction and do not actually overlap.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A force-exerting element for a friction clutch, comprising:
a ring-shaped body having a radially outer edge area and a radially inner edge area, said ring-shaped body defining openings therein, each of a first group of said openings being open toward said radially outer edge and extending to a radially innermost end and each of a second group of said openings being open toward said radially inner edge and extending to a radially outermost end, wherein a first distance between said axis of rotation and said radially innermost ends of said first group of openings is less than or approximately equal to a second distance between said axis of rotation and radially outermost ends of said second group of openings; and
a radial support arrangement radially supporting at least a portion of said ring-shaped body in a direction counter to the effects of centrifugal force on said ring-shaped body.

2. The force-exerting element of claim 1, wherein said radial support arrangement comprises a support ring surrounding a radially outer side of said ring-shaped body.

3. The force-exerting element of claim 2, wherein said support ring defines a recess in which said outer edge area of said ring-shaped body is received.

4. The force-exerting element of claim 3, wherein said outer edge area engages in said recess with freedom of movement with respect to said support ring.

5. The force-exerting element of claim 4, wherein said support ring has a torsional elasticity.

6. The force-exerting element claim 3, wherein said outer edge area of said ring-shaped body is essentially held tightly in said recess.

7. The force-exerting element of claim 6, wherein said support ring has a torsional elasticity.

8. The force-exerting element of claim 2, wherein said support ring is formed by a pressure plate of a friction clutch.

9. The force-exerting element of claim 1, wherein said support arrangement comprises a support ring which cooperates with said ring-shaped body proximate said inner edge area of said ring-shaped body.

10. The force-exerting element of claim 9, further comprising hook-like support areas for supportive interaction provided on at least one of said support ring and said ring-shaped body.

11. The force-exerting element of claim 1, wherein said support arrangement comprises a plurality of support projections connectable to a carrier element in the friction clutch and engageable in said ring-shaped body.

12. The force-exerting element of claim 11, wherein at least some of said support projections are engageable in said ring-shaped body proximate said openings.

13. The force-exerting element of claim 12, wherein at least some of said support projections are engageable in said openings in said body proximate said radial ends thereof.

14. The force-exerting element of claim 11, wherein at least some of said support projections are engageable in said openings in said body proximate said radial ends thereof.

15. The force-exerting element of claim 11, wherein said ring shaped body further defines engagement opening in addition to said first and second groups of openings, at least some of said support projections being engageable in said engagement openings.
